(19) United States
(12) Patent Application Publication
(10) Pub. No.: US 2025/0069076 A1
(43) Pub. Date: Feb. 27, 2025

(54) METHODS AND SYSTEMS FOR RECIPIENT-FACILITATED BLOCKCHAIN TRANSACTIONS

(71) Applicant: nChain Licensing AG, Zug (CH)

(72) Inventors: Jack Owen DAVIES, London (GB); Jad WAHAB, London (GB); Wei ZHANG, London (GB); Mark SMITH, London (GB)

(21) Appl. No.: 18/720,503

(22) PCT Filed: Dec. 8, 2022
(86) PCT No.: PCT/EP2022/085036

§ 371 Date: Jun. 14, 2024

(30) Foreign Application Priority Data
Dec. 23, 2021 (GB) 2118959.2

(51) Int. Cl. G06Q 20/38; G06Q 20/20

(52) U.S. Cl. CPC G06Q 20/389; G06Q 20/20; G06Q 20/3825

(57) ABSTRACT

Systems and computer-implemented methods of generating recipient-facilitated blockchain transactions. A recipient device transmits a recipient outpoint to a sender device. The sender device returns a partially-complete transaction containing the recipient outpoint as a recipient input to the partially-complete transaction and containing at least one sender input. The recipient device then adds a recipient output script as an output to the partially-complete transaction, adds an unlocking script for the recipient outpoint using a digital signature across all input and outputs to produce a complete transaction, and transmits the complete transaction to a blockchain node of a blockchain network for propagation and inclusion in a block

### CROSS REFERENCE TO RELATED APPLICATIONS

This application is the U.S. National Stage of International Application No. PCT/EP2022/085036 filed on Dec. 8, 2022, which claims the benefit of United Kingdom Patent Application No. 2118959.2, filed on Dec. 23, 2021, the contents of which are incorporated herein by reference in their entireties.

### TECHNICAL FIELD

The present disclosure relates to blockchain networks and, in particular, to methods and devices for generating and implementing blockchain transactions that are recipient-facilitated.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The transactions in the blockchain are used to perform one or more of the following: to convey a digital asset (i.e. a number of digital tokens), to order a set of journal entries in a virtualised ledger or registry, to receive and process timestamp entries, and/or to time-order index pointers.

In an “output-based” model (sometimes referred to as a UTXO-based model), the data structure of a given transaction includes one or more inputs and one or more outputs. Any spendable output includes an element specifying an amount of the digital asset that is derivable from the proceeding sequence of transactions. The spendable output is sometimes referred to as a UTXO (“unspent transaction output”) or an “outpoint”. The output may further include a locking script specifying a condition for the future redemption of the output. A locking script is a predicate defining the conditions necessary to validate and transfer digital tokens or assets. Each input of a transaction (other than a coinbase transaction) includes a pointer (i.e. a reference) to such an output in a preceding transaction, and may further include an unlocking script for unlocking the locking script of the pointed-to output.

In order for the blockchain network to be practically useful to large numbers of participants, an end user device may operate a client application (sometime referred to as a “wallet” or Simplified Payment Verification (SPV) software). Such a client application lacks the functionality of a full blockchain node and does not have a full copy of the blockchain.

Blockchain transactions typically involve a transaction fee (and/or ‘gas’ in the case of some protocols) payable to the blockchain node (e.g. miner) that succeed in including the transaction in a properly-mined valid block. The typical model is that the sender node supplies sufficient digital assets (e.g. cryptocurrency) as an input to the transaction, and a portion of the input digital assets are used pay the transaction fee. A specified amount of the digital assets are assigned or transferred to the output script of the recipient node, and any leftover assets are assigned or sent to an output script of the sender as “change”. This turns typical retail consumer transactions upside-down in that, typically, the cost of a monetary transaction is borne by the merchant (recipient), such as credit card fees. This creates a barrier to adoption and use of blockchain systems for day-to-day transactions and may even be prohibited by law or regulation in some jurisdictions. However, the merchant/recipient cannot be expected to provide prospective consumer devices with authorization to charge transaction fees to the merchant in building a transaction since it may necessitate the recipient node providing a suitable input in unlocked form, effectively a “blank cheque”. This might expose a recipient unexpectedly large transaction fees and may be open to abuse and unworkable. It would be advantageous to have methods and systems for carrying out recipient-facilitated blockchain transactions that address at least some of these shortcomings.

### BRIEF DESCRIPTION OF THE DRAWINGS

Reference will now be made, by way of example, to the accompanying drawings which show example embodiments of the present application and in which:

FIG. 1 shows an example system for implementing a blockchain;

FIG. 2 illustrates an example transaction protocol;

FIG. 3A shows an example implementation of a client application;

FIG. 3B shows an example of a user interface for the client application;

FIG. 4 illustrates example node software for a blockchain node;

FIG. 5 shows, in flowchart form, one example method implemented at a recipient device for generating a recipient-facilitated blockchain transaction;

FIG. 6 shows, in flowchart form, one example method implemented at a sender device for generating a partially-complete blockchain transaction;

FIG. 7 shows, in flowchart form, another example method implemented at a recipient device for generating a recipient-facilitated blockchain transaction;

FIG. 8 diagrammatically illustrates a simplified example system for retain transactions;

FIG. 9A-9F illustrate example transaction data structures.

Like reference numerals are used in the drawings to denote like elements and features.

### DETAILED DESCRIPTION OF EXAMPLES

In one aspect, there may be provided a computer-implemented method of generating recipient-facilitated blockchain transactions. The method may include transmitting, from a recipient device to a sender device, a recipient outpoint; receiving, from the sending device, a partially-complete transaction containing the recipient outpoint as a recipient input to the partially-complete transaction and containing at least one sender input; adding a recipient output script as an output to the partially-complete transaction; adding an unlocking script for the recipient outpoint using a digital signature across all input and outputs to produce a complete transaction; and transmitting the complete transaction to a blockchain node of a blockchain network for propagation and inclusion in a block.

In some implementations, the method may include, after receiving the partially-complete transaction, determining that the partially-complete transaction includes one or more digital signatures applied by the sending device to the at least one sender input and fewer than all outputs. In some cases, determining further includes determining that the partially-complete transaction does not contain a signature across all outputs. The determining may include determining that the partially-complete transaction permits addition of the recipient output script without invalidating the one or more digital signatures applied by the sending device. The determining may include determining that all signatures applied by the sender device are of type SIGHASH_SINGLE or SIGHASH_NONE. The determining may include determining that no signature applied by the sender device is of type SIGHASH_ALL.

In some implementations, the method may further include providing the sender device with a maximum condition relating to sender inputs and sender outputs associated with the recipient device. The method may include determining a count of sender inputs and sender outputs in the partially-complete transaction and confirming the count of sender inputs and sender outputs is not greater than a maximum value set by the maximum condition. The method may include determining a byte-size of the sender inputs and sender outputs in the partially-complete transaction and confirming that the byte-size is not greater than a maximum size set by the maximum condition.

In another aspect, there may be provided a computing device for engaging in recipient-facilitated blockchain transactions. The computing device may include memory, one or more processors, and computer-executable instructions that, when executed, cause the processors to carry out one or more of the methods described herein.

In some implementations, transmitting, from a recipient device to a sender device, a recipient outpoint includes generating and sending a transaction template containing the recipient outpoint as an input to the transaction template. In some cases, the transaction template further contains an output script referencing a recipient output address as one output and designates a transfer quantity to that one output.

In some implementations, the method further includes determining a transaction fee; determining an excess quantity from a difference between a stored quantity associated with the recipient outpoint and the transaction fee; and designating the excess quantity to the recipient output script.

In some implementations, the method further includes, at the sender device, generating the partially-complete transaction by selecting the at least one sender input such that an aggregate quantity associated with the at least one sender input is equal to or greater than a transfer quantity; attaching to the partially-complete transaction, a digital signature for each sender input that signs a respective portion of the partially-complete transaction that includes fewer than all outputs; and transmitting the partially-complete transaction to the recipient device.

In a further aspect, the present application describes a computing device having memory, one or more processors, and computer-executable instructions stored in the memory that, when executed by the one or more processors, cause the one or more processors to carry out at least one of the methods described herein.

In yet another aspect, there may be provided a computer-readable medium storing processor-executable instructions that, when executed by one or more processors, cause the processors to carry out at least one of the methods described herein.

Other example embodiments of the present disclosure will be apparent to those of ordinary skill in the art from a review of the following detailed description in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

### Example System Overview

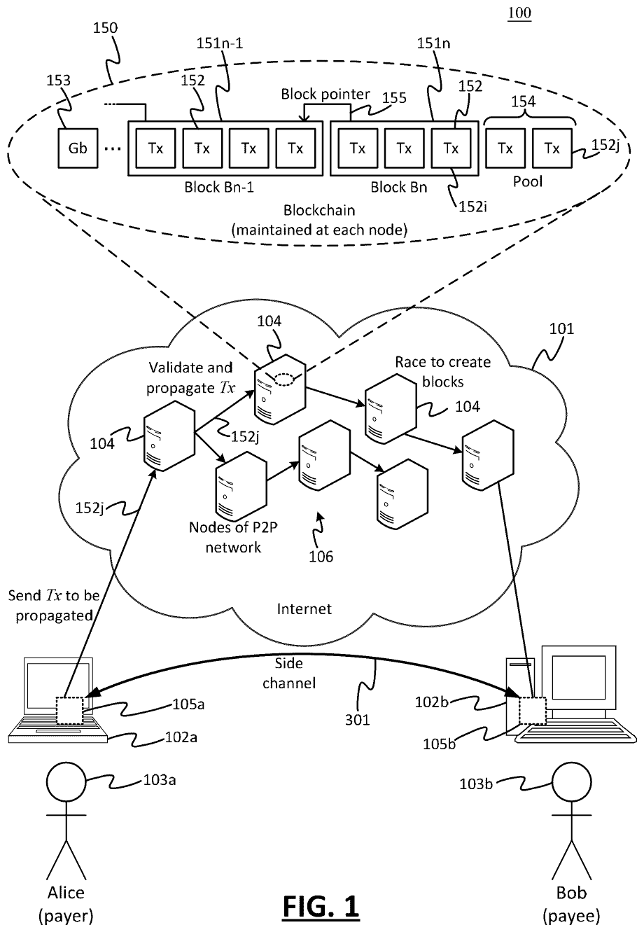

FIG. 1 shows an example system 100 for implementing a blockchain 150. The system 100 may include a packet-switched network 101, typically a wide-area internetwork such as the Internet. The packet-switched network 101 includes a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 includes computer equipment of a peer, with different ones of the nodes 104 belonging to different peers. Each blockchain node 104 includes a processing apparatus implemented by one or more processors, e.g. one or more central processing units (CPUs), accelerator processors, application specific processors and/or field programmable gate arrays (FPGAs), and other equipment such as Application Specific Integrated Circuits (ASICs). Each node also includes memory, i.e. computer-readable storage in the form of a non-transitory computer-readable medium or media. The memory may include one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 includes a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain includes one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 has at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also includes a block pointer 155 pointing back to the previously created block 151 in the chain so as to define a sequential order to the blocks 151. Each transaction 152 (other than a coinbase transaction) has a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input includes a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also includes the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may include checking that the cryptographic signature or other authorisation of the entity 103 included in the input of the new transaction 152j matches a condition defined in the output of the preceding transaction 152i which the new transaction assigns, wherein this condition typically includes at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this includes searching for a “nonce” value such that when the nonce is concatenated with a representation of the ordered set of transactions 154 and hashed, then the output of the hash meets a predetermined condition. For example, the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 15 In pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly-defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server that includes one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus including one or more processors, e.g. one or more CPUs, GPUs, other accelerator processors, application specific processors, and/or FPGAs. The computer equipment 102 of each party 103 further includes memory, i.e. computer-readable storage in the form of a non-transitory computer-readable medium or media. This memory may include one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software such as a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 includes at least one user terminal, e.g. a desktop or laptop computer, a tablet, a smartphone, or a wearable device such as a smartwatch. The computer equipment 102 of a given party 103 may also include one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 includes at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality includes collating the amounts defined in the outputs of the various 152 transactions scattered throughout the blockchain 150 that belong to the party in question.

It will be understood that whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This may include first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151, and eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 includes a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

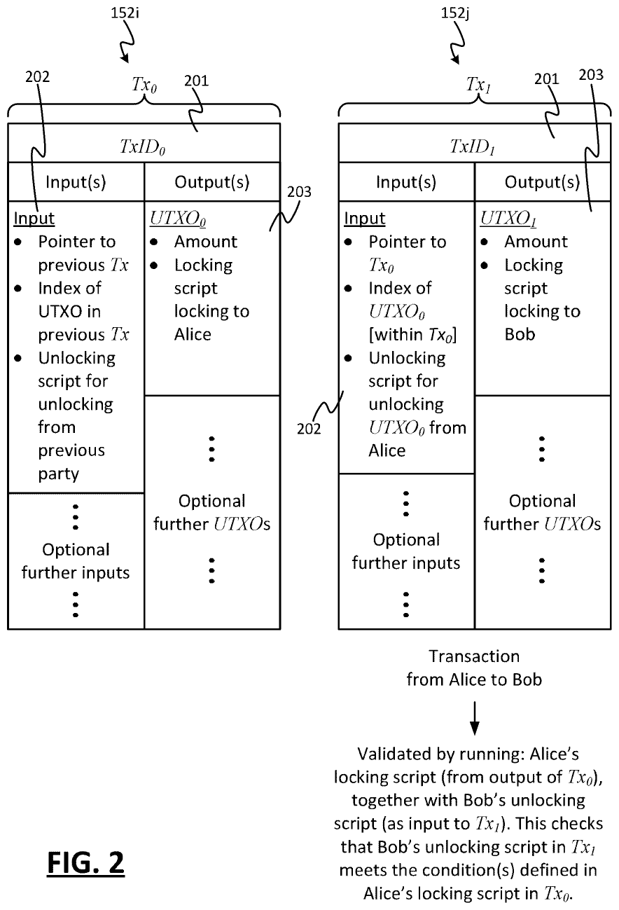

FIG. 2 illustrates an example transaction protocol. This is an example of a UTXO-based protocol. A transaction 152 (abbreviated “Tx”) is the fundamental data structure of the blockchain 150 (each block 151 containing one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 is a data structure having one or more inputs 202, and one or more outputs 203. Each output 203 may include an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also include a header 201, which may include an indicator of the size of the input field(s) 202 and output field(s) 203. The header 201 may also include an ID of the transaction. In some embodiments, the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ is a particular UTXO, labelled here UTXO₀. Each UTXO includes a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). That is, the locking script defines an unlocking condition, typically include a condition that the unlocking script in the input of the subsequent transaction include the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ includes a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ includes a pointer pointing back to Tx₀ (e.g. by means of its transaction ID, TxID₀, which in some embodiments is the hash of the whole transaction Tx₀). The input 202 of Tx₁ includes an index identifying UTXO₀ within Tx₀, to identify it amongst any other possible outputs of Tx₀. The input 202 of Tx₁ further includes an unlocking script <Sig P_{A}> which has a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This may include running the locking script and unlocking script together to check whether the unlocking script meets the condition defined in the locking script (where this condition may include one or more criteria). In some embodiments this may involve concatenating the two scripts:

<Sig P_{A}><P_{A}>∥[Checksig P_{A}]

where “∥” represents a concatenation and “< . . . >” means place the data on the stack, and “[ . . . ]” is a function carried out by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data includes the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically includes hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice, a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However, the amount from the UTXO can be split between multiple outputs of the next transaction. For example, the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. For example, say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing (TX (). Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence, typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. For example, the data could include a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically includes the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed includes authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may include additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may include any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

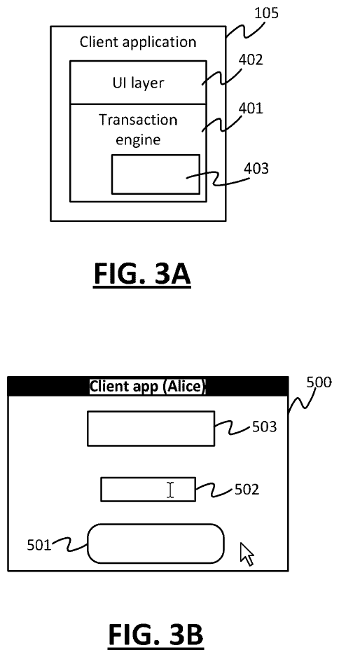

FIG. 3A illustrates an example implementation of the client application 105 for implementing embodiments of the presently disclosed scheme. The client application 105 may include a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the processes discussed above.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could include one or more display screens (touch or non-touch screen) for providing a visual output, one or more speakers for providing an audio output, and/or one or more haptic output devices for providing a tactile output, etc. The user input means could include for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note that whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may include one or more UI elements 501, 502, 502 rendered as distinct UI elements via the user output means.

For example, the UI elements may include one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may include one or more data entry fields 502. These data entry fields 502 are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may include one or more information elements 503 output to output information to the user. For example, the information could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3B is only a schematized mock-up and in practice it may include one or more further UI elements, which for conciseness are not illustrated.

### Node Software

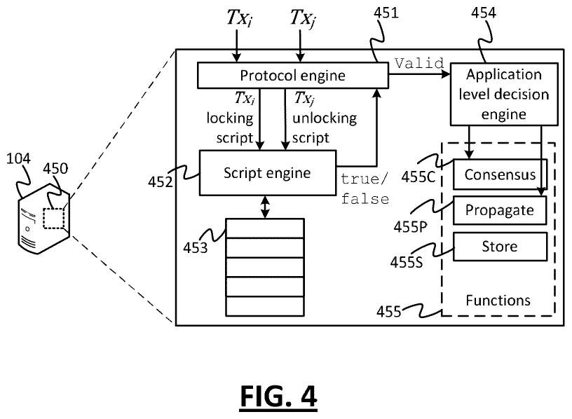

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This may include the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. For example, the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In some embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In some other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Recipient-Facilitated Transactions

As described above, transfer of a digital asset via blockchain transaction typically involves a sending device constructing a transaction that includes as an input a pointer/address of at least one outpoint from a preceding transaction controlled by the sending node. The transaction further includes an output to an output script associated with a recipient device and, in some cases, a further output to an output script associated with the sending device to receive surplus digital assets from the outpoint(s) over and above the quantity intended to go to the recipient's output script. The sending device includes at least one digital signature with the transaction as part of providing the unlocking script for the outpoint(s).

The description herein may use the term “output script” to refer to an output to a transaction. The term “output script” may be synonymous with “locking script” referred to above. In many cases, the output script may be a pay-to-public-key-hash (P2PKH) operation associated with a public key for which a device holds the private key. The public key (or public key hash) may be referred to as an output address in some contexts, in that the digital assets allocated to that public key hash are considered as belonging to that “output address”, such that the device holding the corresponding private key controls access to those digital assets by virtue of its ability to supply the necessary unlocking script to utilize or move those digital assets. In some cases, output scripts may impose more complex conditions or requirements for access to the digital assets.

The sending device that typically constructs such a transaction may or may not send the transaction to the recipient device directly. In some cases the sending device may simply send the transaction to the blockchain network for propagation, validation, and inclusion in a block. The recipient device may monitor the blockchain to detect the transaction, or may receive a copy directly from the sending device.

To guard against malicious changes to the transaction or changes that will invalidate it, the sending device typically applies at least one digital signature across all inputs and outputs. In the context of the bitcoin network, this operation may be implemented using a SIGHASH_ALL operation. That operation generates a digital signature by the sending device using the sender's private key and a hash of substantially all data in the transaction, including all the inputs and all the outputs, thereby preventing any entity from meaningfully modifying the inputs or outputs to the transaction without invalidating the digital signature. In this sense, the transaction constructed by the sending device is a “complete transaction”. That is, as a complete transaction it is valid within the meaning of the blockchain protocol, and may be sent to a bitcoin node for validation and inclusion in a block.

To construct a valid complete transaction, the sending device typically identifies one or more outpoints it controls from preceding transactions such that the aggregate sum of the outpoints is equal to or greater than the transfer quantity that is to be transferred to the recipient device. For instance, if the recipient device is to receive 100 digital tokens, the sending device may identify one or more outpoints from previous transactions that, when added, sum to at least 100digital tokens. In some examples, a single outpoint may be selected that has 100 or more digital tokens. In some other examples, more than one outpoint may be selected that collectively have 100 or more digital tokens. The outpoint(s) selected must also have sufficient tokens to ensure that any transaction fee or other fee or input (e.g. gas) is a part of the inputs to the transaction. That is, if the transaction fee is 3 digital tokens, then the sending device typically needs to ensure that the outpoints selected have an aggregate associated value of at least 103 digital tokens to ensure that the transaction is accepted for inclusion in a block. The quantity of the transaction fee varies in many blockchain networks. It may vary over time dependent upon network congestion. It may vary dependent upon the size of the transaction and/or the quantity of inputs and outputs in the transaction in some cases.

Having selected the necessary outpoints to form the input to the transaction the sending device adds an output script associated with the recipient device and designates it to receive the transfer quantity, e.g. P2PKH to a recipient public key. The transfer quantity is a quantity equal to or less than the aggregate sum of input values minus the transaction fee. Any surplus assets may be returned to the sending device through inclusion of an output script associated with the sending device and assigning the surplus quantity to that output. The sending device then digitally signs the transaction, which may include digitally signing the transaction using at least one SIGHASH_ALL signature that constitutes a signature over at least all the inputs and all the outputs, thereby preventing any meaningful modifications.

The above-described transaction generation process is inconsistent with non-blockchain implemented commercial transactions. In most commercial transactions, the recipient, such as a merchant, absorbs the cost associated with receiving transfer of funds or other such assets, particularly in a retail context. As an example, merchants typically take credit card payments for the listed or displayed cost of a product or service (plus applicable taxes, if any) and absorb the credit card transaction fees as a business expense.

The above-described transaction generation process with the sending device supplying a quantity of digital assets sufficient to cover the transaction fee is a barrier to adoption of blockchain transaction for commercial transactions, particularly retail consumer transactions such as point-of-sale transactions. Indeed, in many jurisdictions, this form of transaction in which the consumer is charged the transaction fee may be contrary to law or regulation. Accordingly, it may be advantageous to provide for a system or method that enables recipient-facilitated blockchain transactions, such as ones in which the digital assets transferred to a mining node as the transaction fee come from the recipient device. The challenge in doing so is to provide for a method and system in which neither the recipient device nor the sending device are exposing data that may be exploited, such that they are writing a “blank cheque”, e.g. generating a transaction that may permit malicious modifications resulting in unauthorized digital transfers. At the same time, the method and system should aim for simplicity and efficiency in the communications flow.

In one aspect, the present application provides systems and methods that enable recipient-facilitated blockchain transactions in which the recipient device provides an outpoint from a previous transaction to the sender device such that the outpoint is included in a constructed partially-complete transaction as an input intended to offset anticipated transaction fees. The sender device adds one or more inputs, and may add one or more outputs to receive excess tokens or funds (e.g. as “change”) over the transfer quantity intended to be transferred to the recipient device. The sender device further digitally signs the inputs using at least one digital signature, but none of the digital signatures are applied over all the outputs. That is, the partially-complete transaction generated by the sender device is signed such that no changes may be made to the inputs or to add an input, and no changes may be made to the outputs already in the partially-complete transaction but one or more outputs may be added. That partially-complete transaction is sent to the recipient device, which then inserts an output script referencing a recipient device address as an output for receiving at least any excess from its input outpoint to the extent it is greater than the transaction fee for the transaction.

In another aspect, the present application provides for recipient-based control over the transaction fee associated with the transaction whilst still enabling generation of the transaction by the sender device by facilitating the imposition of conditions, caps or maximums on the number of inputs and/or outputs permitted in the transaction. In another implementation, the conditions, caps or maximums may also or alternatively include a maximum transaction size, such as in bytes or the like. The partially-complete transaction generated by the sender device is evaluated for compliance with the conditions, caps or maximums by the recipient device. In some cases, those conditions, caps or maximums may be sent to the sender device in the same communication providing the outpoint for the transaction. In some cases, the conditions, caps or maximums may be communicated through another channel, or may be known to the sender device as part of a policy rule set associated with the recipient device. The recipient device may then select conditions, caps or maximums that constrain the transaction size or number of inputs and outputs such that the maximum transaction fee is ascertainable in advance and a suitable outpoint having sufficient digital assets may be selected by the recipient device.

While the present application is not limited to blockchain transactions involving retail consumer transactions, such as between a merchant and a customer obtaining goods or services, that situation provides a useful illustrative example that will be referred to below. The present application may be applied in other situations. Moreover, the present application may be implemented in contexts that involve digital assets or tokens other than cryptocurrencies.

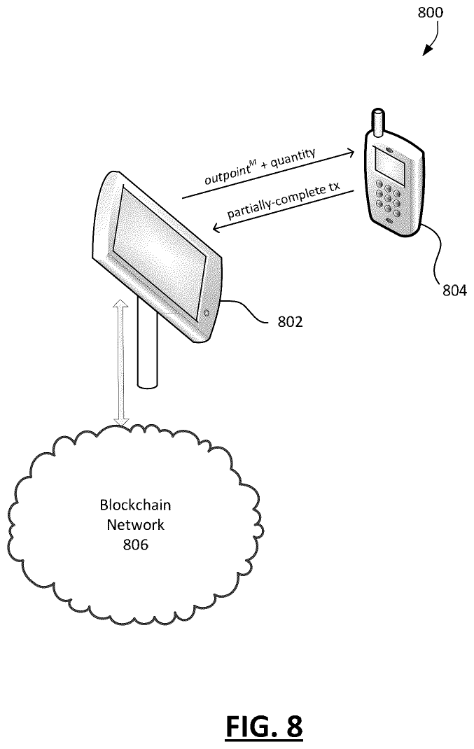

With reference to FIG. 8, a typical merchant-customer system 800 is illustrated. The system 800 may include a point-of-sale (POS) device 802 and a customer device 804. The POS device 802 may be a fixed or mobile terminal device used for entering, manually or through scanning devices, prospective goods or services for purchase. The POS device 802 may display the total payment required for the goods or services and one or more payment methods. In this example, a blockchain payment option may be made available.

The customer device 802 may include a smartphone, tablet, or other mobile computing device having implemented thereon a blockchain wallet application. The customer device 802 may communicate with the POS device 802 using any suitable communications medium and protocol, including Bluetooth™, near-field-communications (NFC), or other short-range communications technology. Various authentication, validation and pairing operations may be carried out that are not germane to the present description.

The POS device 802 in this example may send the customer device 804 data regarding the prospective transaction. The data may include an outpoint controlled by the POS device 802 having an associated asset value sufficient to offset a maximum transaction fee for the prospective transaction. In some implementations, the POS device 802 further sends one or more conditions, maximums or caps relating to the number of inputs/outputs or the transaction size. For instance, the POS device 802 may set a maximum number of inputs n, a maximum number of outputs n′, and/or a maximum transaction size N. In some implementations the POS device 802 generates and sends a transaction template that has the outpoint as a designated input with its associated asset value shown as an input to the prospective transaction. The outpoint in such a transaction template is not yet signed by the POS device 802. The transaction template may, in some examples, include a recipient address to which the transfer quantity (e.g. payment amount) is to be allocated. If the template includes such an address, then the recipient address may be intended to receive only the payment amount (i.e. the purchase price being paid by the customer device 804) and not any excess remaining from the outpoint used to fund transaction fees.

On receipt of this data, the customer device 804 may select one or more customer outpoints from previous transactions that, collectively, have sufficient aggregate associated value to equal or exceed the transaction payment amount. If a transaction template is not received from the POS device 802, then it may be generated by the customer device 804 and the recipient-provided outpoint is also added as an input. The customer device 804 may further add one or more outputs, for example to receive “change” from the difference between the aggregate value of the customer outpoints used as inputs and the total payment amount being sent to the POS device 802.

The number of inputs and outputs used by the customer device 804 is constrained by the maximums prescribed by the POS device 802. In other words, the wallet application on the customer device 804 may select more than one customer outpoint to use as inputs to the transaction, but the number selected must be no greater than the maximum set by the POS device 804. In some implementations, the maximum number of inputs may apply only to customer inputs, but in some other implementations, the maximum may include both customer inputs and the recipient outpoint. Likewise, the number of outputs permitted is constrained by any maximum count of outputs prescribed by the POS device 804. Alternatively, the POS device 804 may set an aggregate maximum input/output condition setting a maximum sum of inputs and outputs. These examples and other such limits may collectively be referred to herein as “a maximum condition on the count of inputs or outputs”. Alternatively or additionally, the overall size of the transaction may be constrained by a prescribed maximum size, thereby limiting the number of inputs, outputs, or additional excess data in the inputs or outputs, such as OP_RETURN codes.

For each customer outpoint added to the transaction, the customer device 804 adds a digital signature enabling access to the outpoint, i.e. provides the unlocking script. However, the type of digital signature used is one which does not sign over all of the outputs. That is, the customer device 802 uses a class of digital signatures (e.g. SIGHASH_SINGLE or SIGHASH_NONE) that apply each digital signature to a hash of a portion of data in the transaction that includes all the inputs but does not include any of the outputs or includes only one of the outputs. In other words, the class of digital signature used does not sign all of the outputs, meaning that an output may be added to the transaction later without rendering the digital signature(s) invalid. Moreover, no input may be added to the transaction later without rendering the digital signature(s) invalid.

It will be understood that other example signature classes in the bitcoin protocol include SIGHASH_ALL|ANYONECANPAY, SIGHASH_SINGLE|ANYONECANPAY, and SIGHASH_NONE|ANYONECANPAY. These types of signatures are only applied to a single input, thereby permitting changes to the inputs without invalidating the signature.

The transaction constructed and signed as described above is a partially-complete transaction. It is not yet complete in that the recipient has not provided a digital signature to enable input of the recipient outpoint. The customer device 804 therefore sends the partially-complete transaction to the POS device 802. The POS device 802 may then verify that the customer signatures are valid or at least that they are of a class of digital signature that avoids signing over the entire set of outputs. If the partially-complete transaction complies with the constraints set by the POS device 802, e.g. in terms of number of inputs/outputs, and the digital signatures from the customer device 804 are valid and are not applied to all outputs, then the POS device 802 may add a recipient output script (such as a recipient address) as an output, for example to receive the payment and any excess funds from the recipient outpoint used to fund the transaction fee. In some cases, the transaction may already include a recipient output script for receiving the payment and the recipient may add a second recipient output script to receive any excess funds from the recipient outpoint used to fund the transaction fee.

The POS device 802 provides a digital signature for the recipient outpoint used to fund the transaction fee payment. This digital signature may be of a class that includes all the outputs in the message signed, so as to prevent any alterations to the outputs of the transaction. It may be one that includes all input and all outputs, such as SIGHASH_ALL. The resulting signed transaction is a complete transaction that the POS device 802 may then transmit to a blockchain node within a blockchain network 806, where it will be validated, propagated and, eventually, confirmed.

Although the above example relates to a point-of-sale terminal such as may be used in a brick-and-mortar retail location, it will be appreciated that in other contexts the merchant computing device may also be implemented by a mobile device, an online e-commerce platform, a web server, or other such computing devices, and that the context for the interaction between the merchant device and the customer device 804 need not be a retail location or involve short-range or near-field communications.

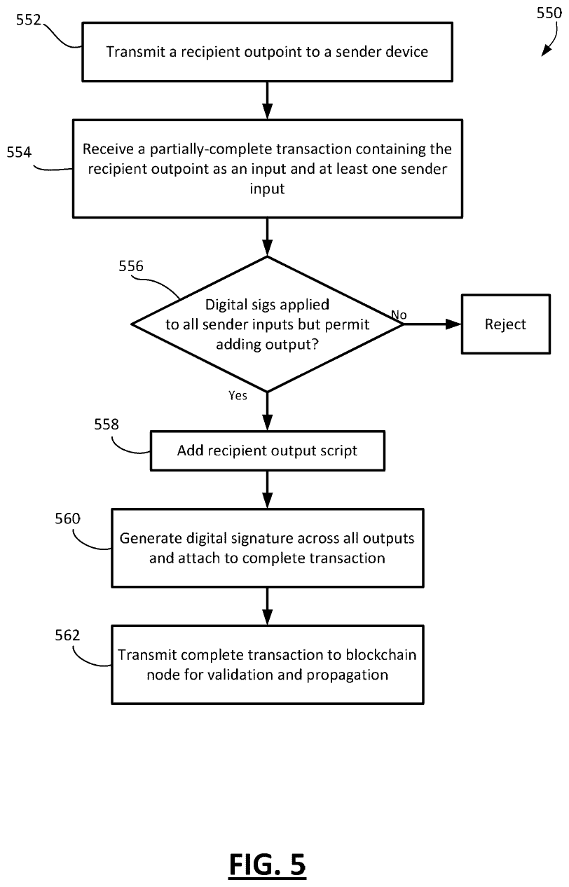

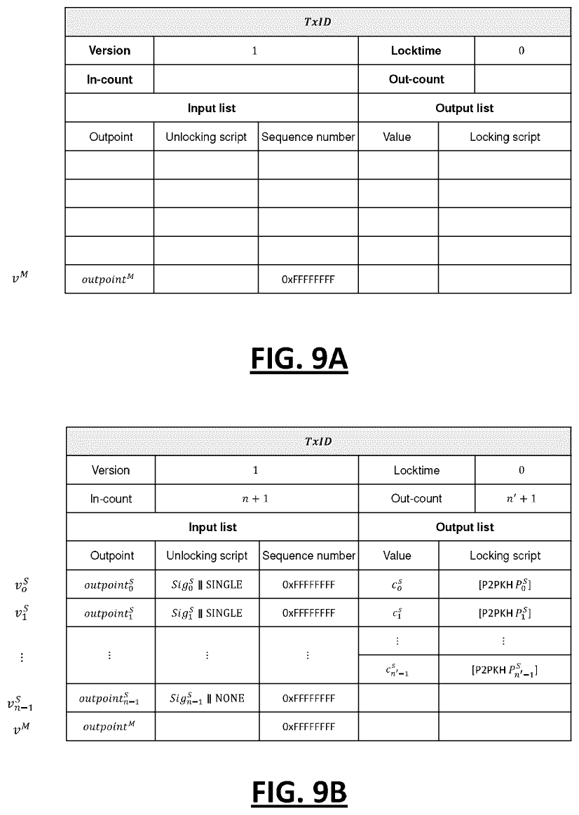

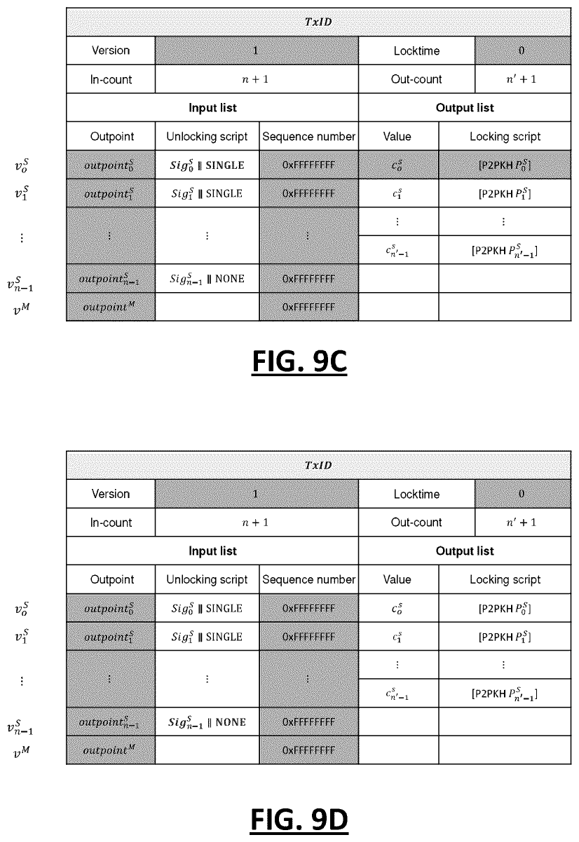

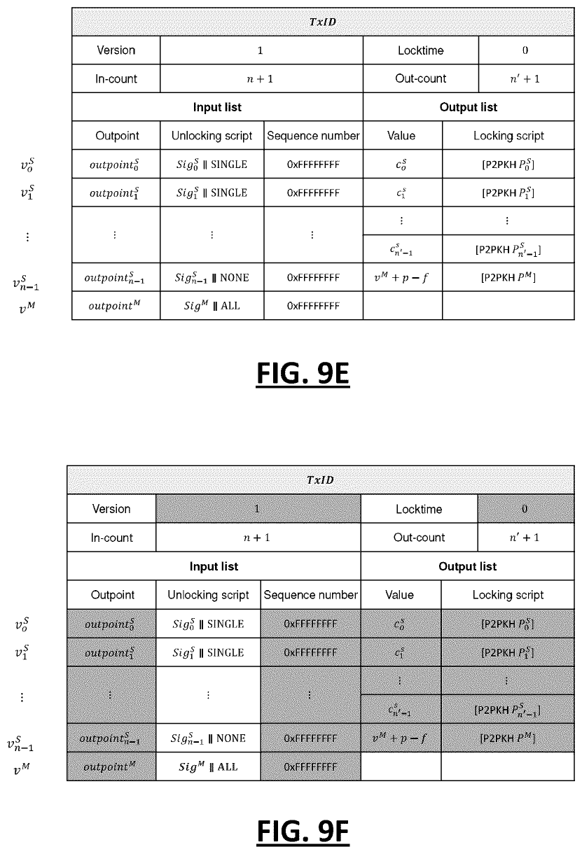

Reference will now be made to FIG. 5 which shows, in flowchart form, one example method 550 of completing a recipient-facilitated transaction. The method 550 may be implemented by a network-connected computing device. In one example, the computing device may be a POS device. The method 550 may be implemented by way of processor-executable instructions that, when executed by a processor, cause the processor to carry out the described operations. The operations may involve memory access functions, signal or data reception or transmission functions, display operations, and other operations involving components coupled to the processor. The instructions may be embodied in one or more software modules, applications, routines, etc. FIG. 5 will be described in conjunction with illustrative example transactions shown in FIGS. 9A-9F.

In this example, the method 550 presumes that the recipient device and sender device are in networked communication and have completed any authentication or handshaking operations, and that a payment quantity has been determined. In operation 552, the recipient device selects and transmits a recipient outpoint outpoint^{M} to a sender device. The recipient outpoint is the outpoint of a previous transaction controlled by the recipient device. The outpoint is selected on the basis that it has sufficient associated value, v^{M}, larger than the anticipated maximum transaction fee for the transaction. The communication to the sender device may further include a payment amount p. In some cases the payment amount p may already have been provided to the sender device through earlier communications or another channel. In some cases, the communication further includes one or more caps or maximums, such as a maximum condition on the number of inputs and outputs, a maximum number of inputs n, a maximum number of outputs n′, and/or a maximum transaction size N. The caps or maximums may be selected to ensure that the transaction fee is at or below a maximum transaction fee.

In one example, the recipient device may send more than one outpoint, each outpoint having a corresponding set of conditions, maximums or caps. The sender device may then select one of the outpoints and be constrained in selecting inputs and outputs to the transaction based on the associated maximums for that outpoint. Incentives may be implemented to bias the sender device to select lower maximums (and thus lower transaction fees for the recipient device), such as by associating them with a lower payment amount, or providing associated loyalty points, vouchers, etc.

Operation 552 may, in some implementations, include generating a transaction template and sending the outpoint within the template. Whether generated by the sender device or generated and sent by the recipient device, the initial transaction template may have the illustrative form shown in FIG. 9A. It will be noted that the recipient outpoint, outpoint^{M}, having an associated value of v^{M} is shown as one of the inputs to the transaction.

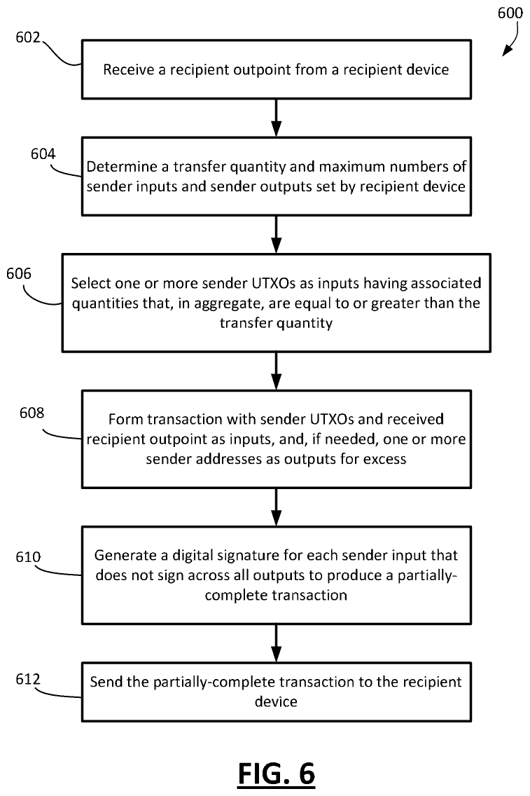

Reference will also now be made to FIG. 6, which shows an example method 600 of generating a partially-complete transaction. The method 600 may be implemented by a sender device, which may be a computing device, such as customer device 804 (FIG. 8). In operation 602, the sender device receives the outpoint identifier from the recipient device. As described above, the recipient device may sent the outpoint, outpoint^{M}, and its associated value of v^{M} in some cases. It may send a transaction template, such as is shown in FIG. 9A in some cases.

The sender device may then, in operation 604, determine a transfer quantity, e.g. a payment amount, and one or more maximums or caps, if applicable. In this sense, the sender device is not “setting” the maximums or caps, but rather is identifying or determining the maximums or caps already set by the recipient device. As noted above, the recipient device may transmit the maximums to the sender device. In some cases, the maximums may be preset by policy rule or other published notification relating to the recipient device. In some cases, the maximums may be specified during an authentication or handshaking process between the sender device and recipient device. The payment amount p may be specified in a communication from the recipient device in some cases. The payment amount may be specified within the transaction template in some cases, through insertion of a recipient address as an output and assignment of the payment amount p to that output (not shown in FIG. 9A).

In operation 606, the sender device selects one or more sender addresses, i.e. sender outpoints from previous transactions (e.g. UTXOs), that in aggregate have a value at least as large as the transfer quantity (e.g. payment amount). The sender device constructs the transaction by adding the selected sender outpoints as inputs to the transaction in operation 608. The set of sender inputs added to the transaction may be designated outpointᵢ^{s}, where index i ranges from 0 up to the maximum of n. In some cases, the sender device may only include one input: outpoint₀^{s}. Nevertheless, for illustrative purpose, FIG. 9B shows the transaction structure with the maximum number of inputs ranging from index 0 to index n-1. Each of the sender inputs, outpointᵢ^{s}, has an associated value, indicated as vᵢ^{s}.

In operation 608, the sender device may add one or more sender output scripts [Pⱼ^{S}] for receiving “change”, to the extent that the sum of input values, e.g. Σvᵢ^{S}, exceeds the payment amount p, wherein Pⱼ^{S} denotes the j^{th} key possessed by the sender. In an edge case, the sum of input value exactly matches the payment amount and no sender output is added. The one or more sender output scripts may be designated and each has an assigned value cⱼ^{S} specified in the transaction as being allocated to that address (i.e. sender public key). The index j may range from 0 up to the maximum count of n′-1. Note that in many cases the sender device is likely to provide a single output script, P₀^{S}, for receiving transfer of surplus assets from the inputs; however, there may be circumstances in which the wallet application of the sender device is configured to preferentially allocate funds to addresses in smaller quantities or denominations, thereby resulting in the wallet inserting more than one output script for receiving excess funds (e.g. change). FIG. 9B illustrate an example in which the sender device includes the maximum number of output scripts. The sum of values allocated to the sender outputs Σcⱼ^{S} equals the sum of input values Σvᵢ^{S} minus the payment amount p.

In operation 610, the sender device applies at least one digital signature. In this example, each sender input has an associated digital signature to unlock that UTXO. It will be noted that the digital signatures applied by the sender device, as shown in the column labelled “Unlocking script”, are of a type that does not sign over all the outputs. For example, the operation indicated as Sig₀^{S}∥SINGLE signs the inputs and the single output having the same index value. The operation shown as Sigₙ₋₁^{S}∥NONE signs only the inputs and none of the outputs. In one implementation, the sender device signs any of its sender inputs, e.g. outpointᵢ^{S}, with SIGHASH_SINGLE if that index i has a corresponding sender output script, Pᵢ^{S}. If there is no corresponding sender output script for that index i then the sender device uses SIGHASH_NONE.

FIG. 9C shows, using shading, the portions of the transaction that are included in the message signed by Sig₀^{S}∥SINGLE. Note that the signed message includes some header metadata, all inputs, and the one output having the same index i=0. FIG. 9D shows, using shading, the portions of the transaction that are included in the message signed by Sigₙ₋₁^{S}∥NONE. Note that the signed message includes some header metadata and all inputs, but none of the outputs. Different blockchain protocols may include different portions of the header metadata in the digital signature process.

Once the transaction's sender inputs have been digitally signed by the sender device, the transaction is “partially-complete”. Note that the recipient outpoint, outpoint^{M}, has not yet been signed by the recipient device and, hence, is not yet unlocked. Accordingly, the transaction is not yet valid in terms of the blockchain protocol. The partially-complete transaction is sent from the sender device to the recipient device in operation 612. While the present description illustrates the partially-complete transaction as being in a particular form or template, the partially-complete transaction sent to the recipient device may include the data in a different format or order, from which the recipient device is to re-arrange the data into a properly-compliant transaction format and/or order.

Referring again to FIG. 5, in operation 554, the sender device receives the partially-complete transaction constructed by the sender device. It then, in operation 556, verifies that the inputs are digitally signed by the sender device. It may validate the signatures in most implementations (rather than relying on a blockchain node to reject the transaction if they are not valid). It may verify that the types of digital signatures used are of a class that permits the recipient node to add an output to the transaction without invalidating the signatures. In the context of bitcoin, this may include confirming that none of the sender's digital signatures are of the type SIGHASH_ALL or SIGHASH_ALL|ANYONECANPAY, or confirming that each of the sender's digital signatures if of type SIGHASH_SINGLE or SIGHASH_NONE.

Based on the count of inputs and outputs, the recipient device may determine the transaction fee f for the transaction and may therefore assess the extent to which the value v^{M} of its recipient input, outpoint^{M}, exceeds the transaction fee f. It therefore is able to determine the quantity of excess assets that should be returned to it.

If the transaction is correctly signed and formed, then in operation 558 the recipient node may add an output script to the partially-complete transaction. The output script added may be a payment address intended to receive the payment amount p plus any excess funds from the outpoint^{M} to the extent that the value v^{M} of that input exceeds the transaction fee f payable. In another implementation, the recipient device may add one or more output scripts designated to receive the payment amount p, and a separate one or more output scripts designated to receive the excess of v^{M}-f. In some implementations, the payment address may have been provided to the sender device and may already be present in the partially-complete transaction. The recipient device may then, based on the count of inputs and outputs, determine the transaction fee f and insert one or more output scripts for storing the excess v^{M}-f.

After adding one or more output scripts, if any, the recipient device then adds the unlocking script for its recipient input. That is, it provides a digital signature using its private key associated with the outpoint^{M}. The digital signature is applied to a message text that includes all inputs and outputs to the transaction, thereby preventing any further alterations to the transaction. In a bitcoin context, this may be the SIGHASH_ALL operation.

FIG. 9E illustrates the transaction after the recipient device adds an output script P^{M}. The value allocated to that output script is the payment amount p plus the difference between the recipient input v^{M} and the transaction fee f. Also shown is the SIGHASH_ALL digital signature operation in the unlocking script for the recipient input. FIG. 9F illustrates, with shading, those portions of the transaction that form the message signed by the Sig^{M}∥ALL digital signature operation. It will be noted that the message text includes header metadata and all inputs and outputs.

Once the transaction has been digitally signed in operation 560, then the transaction is a complete transaction and, in operation 562, the recipient device transmits it to one or more blockchain nodes in a blockchain network for validation, propagation, and confirmation.

The foregoing examples and illustrations provide for methods and systems that preserve the general communications flow of SPV payments involving a message from merchant device to customer device and a return message from customer device to merchant device. Nevertheless, through the providing of a merchant/recipient input outpoint, unsigned, the recipient device is able to both supply digital assets for the transaction fee yet maintain control over transaction bloat and the size of the transaction fee by controlling the insertion of the final output address for receiving excess funds not consumed by the transaction fee, and applying the final digital signature for its own input to complete the transaction and render it valid.

As noted above, a challenge to providing a sufficiently large recipient input to fund transaction fees is that the providing of that input, unfettered, may enable abuse and waste by the sender device through addition of excess inputs and outputs. The recipient device may impose conditions, caps or maximums on the count of inputs and outputs to control the maximum transaction fee, enable pre-selection of a suitable recipient input to fund that fee, and to prevent transaction bloat.

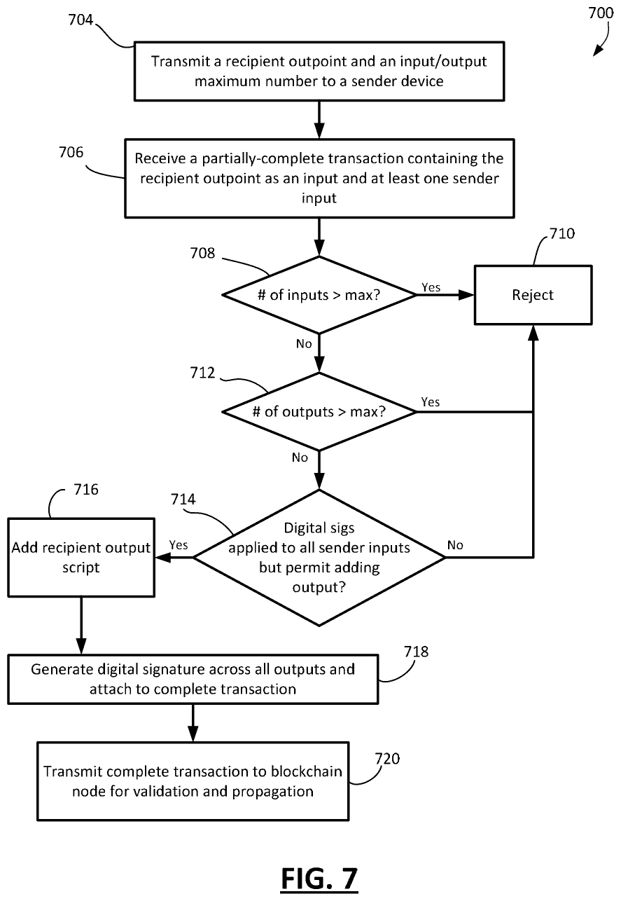

Reference is now made to FIG. 7, which shows, in flowchart form, another example method 700 of completing a recipient-facilitated transaction. The method 700 may be implemented by a network-connected computing device. In one example, the computing device may be a POS device. The method 700 may be implemented by way of processor-executable instructions that, when executed by a processor, cause the processor to carry out the described operations. The operations may involve memory access functions, signal or data reception or transmission functions, display operations, and other operations involving components coupled to the processor. The instructions may be embodied in one or more software modules, applications, routines, etc.

In operation 702, the recipient device may determine a transfer quantity, e.g. a quantity of digital assets to be received from the sender device. It may then, in operation 704, transmit to the sender device the transfer quantity, an outpoint identifier to be used as a recipient input to a transaction, and one or more input and output cap parameters or conditions. As examples, the recipient device may send an input maximum count n and an output maximum count n′. These maximums may specify the maximum number of inputs and outputs, respectively, that the sender device is permitted to add to the transaction. In one example, the recipient device may send a single maximum that is a maximum aggregate count of inputs and outputs that the sender device is permitted to add to the transaction. In another example, the maximum condition may take the form a*n+b*n′<K, wherein a and b are byte-sizes of a P2PKH unlocking and locking script, respectively, and K is a max value selected by the recipient device, thereby enabling the sender device to select n and n′ to satisfy the maximum condition. In yet another example, the maximum condition may take the form A+B<K, where A and B are the total byte-size of the set of sender inputs and sender outputs, respectively, and K is a max value set by the recipient device. As noted earlier, in some implementations, the recipient device may set a set of maximums corresponding to different maximum transaction fees, and the sender device may select from among the set of maximums.

In operation 706, the recipient device receives a partially-complete transaction from the sender device. The partially-complete transaction includes the recipient outpoint as one of the inputs and at least one sender input. It may further include one or more sender outputs for receiving excess funds if the value of the sender inputs exceeds the transfer quantity. The sender inputs include unlocking scripts that include digital signature(s) over the inputs. The digital signatures do not sign over all of the outputs.

In this example, in operation 708, the recipient device evaluates whether the number of sender inputs in the transaction exceeds the input maximum count n. If so, then the recipient device rejects the transaction in operation 710. This may include sending a notification to the sending device of the rejected transaction. The notification may include an indication of the reason for failure, e.g. excessive inputs over maximum permitted. Either or both of the recipient device and the sending device may display or otherwise output a notification to the user indicating that the transaction has failed due to non-compliance with a condition. In some cases, the recipient and sender devices may re-initiate the transaction generation in order to correct for the problem.

In operation 712, the recipient device determines whether the count of sender outputs exceeds the output maximum count. If so, then the transaction is rejected in operation 710.

It will be appreciated that operations 708 and 712 may be modified in the case of a differently formulated condition. For example, if the maximum condition is of the form the form a*n+b*n′<K, as described above, then the recipient device totals the byte-size of the inputs and outputs to determine whether they are less than the value K.

In operation 714, the recipient device may determine whether the digital signatures applied to the sign the sender inputs are of a type or class that digitally sign a message that includes all inputs but does not include all outputs. In the context of bitcoin, this may include ensuring that any digital signature applied to a sender input with no sender output at the corresponding index is a SIGHASH_NONE operation, and that any digital signature applied to a sender input with a corresponding sender output at the same index is a SIGHASH_SINGLE operation. It may also or alternatively include verifying that none of the digital signature operations are SIGHASH_ALL operations. In some cases, operation 714 further includes verifying the digital signatures. In general, operation 714 includes determining that addition of an output to the transaction will not invalidate the digital signatures applied by the sender device. If the digital signatures are non-compliant, then the transaction is rejected in operation 710.

Assuming the transaction meets the tests of operations 708, 712, and 714, then in operation 716 the recipient device adds an output script for receiving the residual quantity to the extent that the value of the recipient input, v^{M}, exceeds the transaction fee f. In some cases, the same output address may also be used to receive the transfer quantity. In some cases, a second recipient output script may be added to receive the transfer quantity. In some implementation, a recipient output script may already be in the partially-complete transaction for receiving the transfer quantity.

In operation 718, the recipient device then digitally signs the recipient input using a digital signature that signs over all the inputs and outputs. In the context of bitcoin, this may be the SIGHASH_ALL operation. This digital signature thus locks the inputs and outputs in place such that they cannot be changed without invalidating the signature and the transaction. The complete transaction may then be send to a blockchain node in operation 720 for validation, propagation and eventual confirmation.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method of generating recipient-facilitated blockchain transactions, the method comprising:
transmitting a recipient outpoint from a recipient device to a sender device;
receiving, at the recipient device from the sender device, a partially-complete transaction containing the recipient outpoint as a recipient input to the partially-complete transaction and containing at least one sender input;
determining that the partially-complete transaction includes one or more digital signatures applied by the sender device to the at least one sender input and fewer than all outputs;
adding a recipient output script as an output to the partially-complete transaction;
adding an unlocking script for the recipient outpoint using a digital signature across all input and outputs to produce a complete transaction; and
transmitting the complete transaction from the recipient device to a blockchain node of a blockchain network for propagation and inclusion in a block.

2. The method of claim 1, wherein determining further includes determining that the partially-complete transaction does not contain a signature across all outputs.

3. The method of claim 1, wherein determining that the partially-complete transaction includes one or more digital signatures applied by the sender device to the at least one sender input and fewer than all outputs includes determining that the partially-complete transaction permits addition of the recipient output script without invalidating the one or more digital signatures applied by the sender device.

4. The method of claim 1, wherein determining that the partially-complete transaction includes one or more digital signatures applied by the sender device to the at least one sender input and fewer than all outputs includes determining that all signatures applied by the sender device are of type SIGHASH_SINGLE or SIGHASH_NONE.

5. The method of claim 1, wherein determining includes determining that no signature applied by the sender device is of type SIGHASH_ALL.

6. The method of claim 1, further comprising the recipient device providing the sender device with a maximum condition relating to sender inputs and sender outputs.

7. The method of claim 6, further comprising the recipient device determining a count of sender inputs and sender outputs in the partially-complete transaction and confirming the count of sender inputs and sender outputs is not greater than a maximum value set by the maximum condition.

8. The method of claim 6, further comprising determining a byte-size of the sender inputs and sender outputs in the partially-complete transaction and confirming that the byte-size is not greater than a maximum size set by the maximum condition.

9. The method of claim 1, wherein transmitting the recipient outpoint from the recipient device to the sender device includes generating and sending a transaction template containing the recipient outpoint as an input to the transaction template.

10. The method of claim 9, wherein the transaction template further contains an output script referencing a recipient output address as one output and designates a transfer quantity to that one output.

11. The method of claim 1, further comprising, at the recipient device:
determining a transaction fee;
determining an excess quantity from a difference between a stored quantity associated with the recipient outpoint and the transaction fee; and
designating the excess quantity to the recipient output script.

12. The method of claim 1, further comprising, at the sender device, generating the partially-complete transaction by:
selecting the at least one sender input such that an aggregate quantity associated with the at least one sender input is equal to or greater than a transfer quantity;
attaching to the partially-complete transaction, a digital signature for each sender input that signs a respective portion of the partially-complete transaction that includes fewer than all outputs; and
transmitting the partially-complete transaction to the recipient device.

13. A computing device, the computing device including:
one or more processors;
memory;
computer-executable instructions stored in the memory that, when executed by the one or more processors, cause the one or more processors to:
transmit a recipient outpoint from a recipient device to a sender device;
receive, at the recipient device from the sender device, a partially-complete transaction containing the recipient outpoint as a recipient input to the partially-complete transaction and containing at least one sender input;
determine that the partially-complete transaction includes one or more digital signatures applied by the sender device to the at least one sender input and fewer than all outputs;
add a recipient output script as an output to the partially-complete transaction;
add an unlocking script for the recipient outpoint using a digital signature across all input and outputs to produce a complete transaction; and
transmit the complete transaction from the recipient device to a blockchain node of a blockchain network for propagation and inclusion in a block

14. The computing device of claim 13, wherein the computing device comprises a point of sale terminal.

15. A non-transitory computer-readable medium storing processor-executable instructions, the processor-executable instructions including instructions that, when executed by one or more processors, cause the one or more processors to:
transmit a recipient outpoint from a recipient device to a sender device;
receive, at the recipient device from the sender device, a partially-complete transaction containing the recipient outpoint as a recipient input to the partially-complete transaction and containing at least one sender input;
determine that the partially-complete transaction includes one or more digital signatures applied by the sender device to the at least one sender input and fewer than all outputs;
add a recipient output script as an output to the partially-complete transaction;
add an unlocking script for the recipient outpoint using a digital signature across all input and outputs to produce a complete transaction; and
transmit the complete transaction from the recipient device to a blockchain node of a blockchain network for propagation and inclusion in a block.

16. The computing device of claim 13, wherein the instructions, when executed, are to cause the one or more processors to determine that the partially-complete transaction includes one or more digital signatures applied by the sender device to the at least one sender input and fewer than all outputs by determining that the partially-complete transaction permits addition of the recipient output script without invalidating the one or more digital signatures applied by the sender device.

17. The computing device of claim 13, wherein the instructions, when executed, are to cause the one or more processors to determine that the partially-complete transaction includes one or more digital signatures applied by the sender device to the at least one sender input and fewer than all outputs by determining that all signatures applied by the sender device are of type SIGHASH_SINGLE or SIGHASH_NONE.

18. The computing device of claim 13, wherein the instructions, when executed, are to cause the one or more processors to determine that the partially-complete transaction includes one or more digital signatures applied by the sender device to the at least one sender input and fewer than all outputs by determining that no signature applied by the sender device is of type SIGHASH_ALL.

19. The computing device of claim 13, wherein the instructions, when executed, are to further cause the one or more processors to provide the sender device with a maximum condition relating to sender inputs and sender outputs.

20. The computing device of claim 19, wherein the instructions, when executed, are to further cause the one or more processors to determine a count of sender inputs and sender outputs in the partially-complete transaction and confirm the count of sender inputs and sender outputs is not greater than a maximum value set by the maximum condition.
